(19) United States
(12) Patent Application Publication
(10) Pub. No.: US 2026/0095397 A1
(43) Pub. Date: Apr. 2, 2026

(54) ADDRESSING PREDICTED UNHEALTHY CONDITIONS OF NETWORK LINKS

(71) Applicant: HEWLETT PACKARD ENTERPRISE DEVELOPMENT LP, Spring, TX (US)

(72) Inventors: Nilakantan Mahadevan, Minneapolis, MN (US); Robert James Zirkel, Bloomington, MN (US); David Field Winchell, Nashua, NH (US); Michael Alan Peterson, Chippewa Falls, WI (US)

(21) Appl. No.: 18/901,019

(22) Filed: Sep. 30, 2024

(51) Int. Cl. H04L 43/0817; H04L 41/0654; H04L 43/16

(52) U.S. Cl. CPC H04L 43/0817; H04L 41/0654; H04L 43/16

(57) ABSTRACT

In some examples, a system monitors health metrics associated with a plurality of edge links connecting a collection of switches to electronic devices. The system predicts, based on a pattern of the health metrics, an unhealthy condition of a first edge link of the plurality of edge links. Based on the predicting, a workload manager triggers a maintenance mode for an electronic device connected to the first edge link to address the predicted unhealthy condition, wherein while the electronic device is in the maintenance mode the workload manager avoids scheduling any further workloads on the electronic device.

### BACKGROUND

Electronic devices can communicate through a network, which includes switches that are able to forward data of the electronic devices. The switches are able to forward data packets along network paths based on addresses in the data packets.

### BRIEF DESCRIPTION OF THE DRAWINGS

Some implementations of the present disclosure are described with respect to the following figures.

FIG. 1 is a block diagram of a network arrangement including switches, computing nodes, a fabric manager, a workload manager, and a health monitoring system, in accordance with some examples.

FIG. 2 is a block diagram of an arrangement including a workload manager, a fabric manager, a health monitoring system, a switch, and a computing node, according to some examples.

FIG. 3 is a flow diagram of a process of detecting and addressing unhealthy inter-switch links, according to some examples.

FIG. 4 is a flow diagram of a process of detecting and addressing unhealthy edge links, according to some examples.

FIG. 5 is a flow diagram of a process according to some examples.

FIG. 6 is a block diagram of a system according to some examples.

FIG. 7 is a block diagram of a storage medium storing machine-readable instructions according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

A large computing environment such as a high-performance computing (HPC) environment can include many electronic devices that interact with one another to execute workloads. Communications among the electronic devices are performed through switches of a network. An arrangement of switches can include local groups of switches, where each local group includes switches that may be interconnected to one another over multiple local links. Further, the local groups of switches may be interconnected to one another over global links. Electronic devices executing workloads are connected to switches over edge links. Due to hardware or software issues, some network links (any or some combination of local links, global links, or edge links) may experience errors that cause the network links to go down or become temporarily unavailable. A network link is temporarily available while the network link resets and then reactivates, e.g., after a few seconds or minutes). The network link going down and then coming back up is referred to as a link flap. A network link being unavailable (even temporarily) may cause data packet drops. Data packet drops can cause workloads in electronic devices to fail or to experience workload delays associated with resending dropped data packets. In a large computing environment with many switches, a network path between a source electronic device and a destination electronic device can include multiple hops, where a "hop" refers to a traversal of a network link. Any network link in the network path becoming unavailable will cause a communication failure that would have to be addressed by resending data packets or restarting workloads.

In accordance with some implementations of the present disclosure, preemptive link fault mitigation systems and techniques are provided to predict network link faults and to respond to the predicted network link faults by diverting data traffic or workloads from using network links that may become unavailable due to the degraded health of the network links. In some examples, a preemptive link fault mitigation system monitors health metrics associated with: (1) edge links connecting a collection of switches to electronic devices, and (2) inter-switch links connecting switches to one another. Based on a pattern of the health metrics, the preemptive link fault mitigation system predicts an unhealthy condition of a network link. Based on the prediction of the unhealthy condition of the network link, the preemptive link fault mitigation system triggers a remediation action.

If the network link predicted to be unhealthy is an edge link connecting an electronic device (executing a workload) to a switch, the preemptive link fault mitigation system can alert a workload scheduler, which triggers a maintenance mode for the electronic device connected to the network link. While the electronic device is in the maintenance mode, any existing workload executing in the electronic device is allowed to complete, but the workload scheduler avoids scheduling any further workloads on the electronic device.

If the network link predicted to be unhealthy is an inter-switch link connecting switches, the preemptive link fault mitigation system can alert a fabric manager. In response to the alert, the fabric manager can update forwarding information in at least one switch connected to the inter-switch link. The updated forwarding information re-routes (diverts) any subsequently transmitted data away from the inter-switch link.

Techniques or mechanisms according to some examples of the present disclosure improve computer functionality and the relevant technology by reducing the likelihood of traffic disruption caused by unavailable network links. By avoiding traffic disruption, workloads executing in electronic devices can execute more efficiently as a result of not having to resend data packets or restart processes of the workloads. Additionally, a workload scheduler can avoid scheduling workloads on electronic devices connected to edge links predicted to experience faults, so that workloads are not run on electronic devices that may experience communication issues.

As used here, a "switch" refers to a network device in a network, where the network device is to forward data packets along paths in the network based on address information in the data packets. A "data packet" can refer to any unit of information that can be transmitted separately from any other unit of information over the network. An example of address information in a data packet includes an Internet Protocol (IP) address. Another example of address information in a data packet includes a Media Access Control (MAC) address.

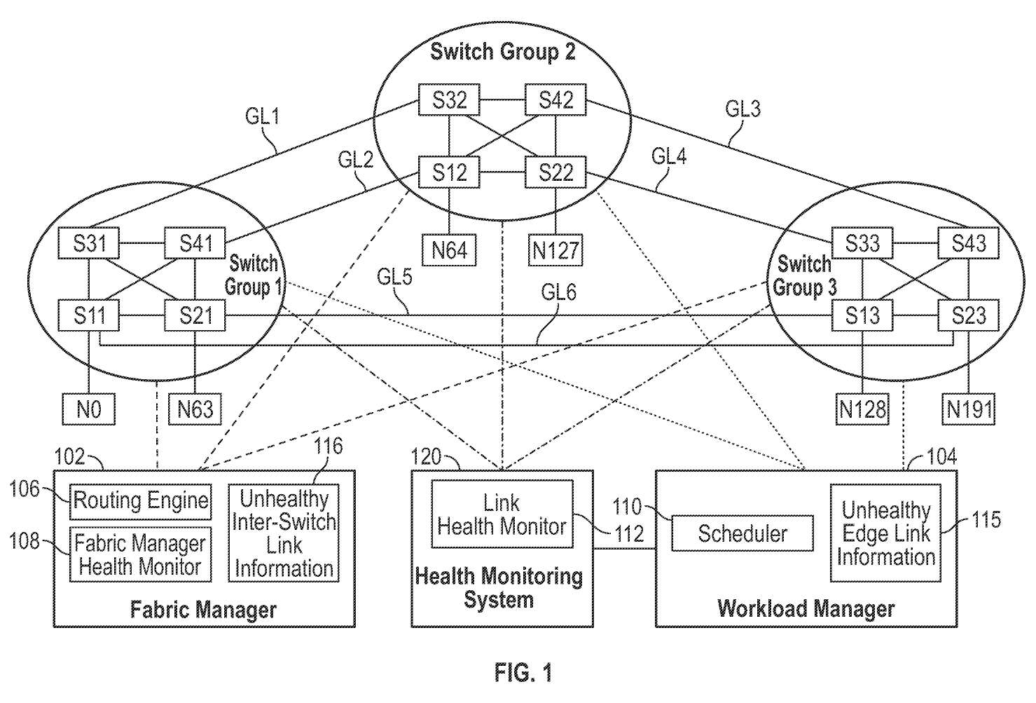

FIG. 1 is a block diagram of an example network arrangement including switches, computing nodes connected to the switches, a fabric manager 102, a workload manager 104, and a health monitoring system 120. In the example of FIG. 1, the switches are arranged in groups of switches, where each switch group includes a collection of switches. As used here, a "collection" of items can refer to a single item or multiple items. Thus, a collection of switches in a switch group can include a single switch or multiple switches.

Each of the fabric manager 102, the workload manager 104, and the health monitoring system 120 can be implemented using one or more computers. In some cases, any combination of the fabric manager 102, the workload manager 104, and the health monitoring system 120 can be implemented using the same collection of computers.

FIG. 1 shows three switch groups: Switch Group 1, Switch Group 2, and Switch Group 3. In other examples, a different quantity of switch groups may be deployed. In alternative examples, switches are not divided into switch groups.

Switch Group 1 includes a switches S11, S21, S31, and S41, Switch Group 2 includes switches S12, S22, S32, and S42, and Switch Group 3 includes switches S13, S23, S33, and S43. Although the example shows each switch group having four switches, it is noted that a switch group can have more or less switches. Further, the quantity of switches in one group may differ from the quantity of switches in another group.

In some examples, within a switch group, each switch is connected to every other switch in a mesh connection arrangement. Thus, for example, in Group 1, switch S11 is connected to each of switches S21, S31, and S41 over respective local links. Similarly, switch S21 is connected to each of switches S11, S31, and S41 over respective local links, switch S31 is connected to each of switches S11, S21, and S41 over respective local links, and switch S41 is connected to each of switches S11, S21, and S31 over respective local links. In further examples, within a switch group, at least one switch may not be connected to another switch in the switch group.

In a specific example, the network arrangement of FIG. 1 is according to a hierarchical network topology such as the Dragonfly network topology. In the Dragonfly network topology, switches are arranged in multiple Dragonfly groups that form local switch groups. In other examples, the network arrangement can use other network topologies, such as a fat tree topology.

A switch includes a number of ports. A "port" can refer to any interface (either physical or logical) through which the switch communicates with another device, which can be a computing node or another switch. A port of a switch that is connected to a computing node is referred to as an edge port, while a port of a switch connected to another switch is referred to as a switch port.

In some examples, a switch can be a high radix switch, which is a switch including a large quantity of ports. High radix switches are used to build larger scale systems, such as HPC systems including a large quantity of computing nodes on which workloads are executed. Examples of workloads include artificial intelligence (AI) workloads, machine learning workloads, image processing workloads, or other types of workloads.

As further shown in FIG. 1, switches in one switch group can be connected to switches in another switch group. For example, switch S31 in Switch Group 1 is connected over a global link GL1 to switch S32 in Switch Group 2, and switch S41 in Switch Group 1 is connected over global link GL2 to switch S12 in Switch Group 2. Similarly, global link GL3 connects switch S42 in Switch Group 2 to switch S43 in Switch Group 3, and global link GL4 connects switch S22 in Switch Group 2 to switch S33 in Switch Group 3. Global link GL5 connects switch S21 in Switch Group 1 to switch S13 in Switch Group 3, and global link GL6 connects switch S11 in Switch Group 1 to switch S23 in Switch Group 3. In other examples, there may be fewer or more global links between any two switch groups.

A switch port of a switch that is connected to another switch over a local link in the same switch group is referred to as a local port, while a switch port in a switch of one switch group that is connected over a global link to another switch in another switch group is referred to as a global port.

Computing node N0 is connected over an edge link to an edge port of switch S11 in Switch Group 1, computing node N63 is connected over an edge link to an edge port of switch S22 in Switch Group 1, computing node N64 is connected over an edge link to an edge port of switch S12 in Switch Group 2, computing node N127 is connected over an edge link to an edge port of switch S22 in Switch Group 2, computing node N128 is connected over an edge link to an edge port of switch S13 in Switch Group 3, and computing node N191 is connected over an edge link to an edge port of switch S23 in Switch Group 3. Other computing nodes (not shown) may be connected to other edge ports of the switches.

The fabric manager 102 includes a routing engine 106 and a fabric manager health monitor 108, and the workload manager 104 includes a scheduler 110. In some examples, such as according to FIG. 1, the health monitoring system 120 is separate from the workload manager 104. The separate health monitoring system 120 includes a link health monitor 112 to detect unhealthy edge links, and the link health monitor 112 can notify the workload manager 104 of such unhealthy edge links that are to be avoided. In other examples, instead of using the separate health monitoring system 120, the link health monitor 112 can be included in the workload manager 104. In further examples, instead of including the fabric manager health monitor 108 in the fabric manager 102, the fabric manager health monitor 108 can be included in the health monitoring system 120 or another health monitoring system. Techniques or mechanisms discussed below are applicable to any of the different arrangements regardless of where health monitors are placed.

The routing engine 106 in the fabric manager 102 is responsible for programming routing information in switches for determining how data packets are to be routed through paths associated with the network arrangement of FIG. 1 based on network addresses (e.g., IP addresses) contained in the data packets. In some examples, the routing information programmed in a switch includes a routing table stored in a memory of the switch. The routing table includes multiple entries, where each entry maps a combination of a source IP address and a destination IP address to a respective network path that the data packet containing the source IP address and the destination IP address is to take. A source IP address identifies a source of the data packet, and the destination IP address identifies a destination of the data packet.

The scheduler 110 of the workload manager 104 places workloads across computing nodes. The placement of workloads can be based on applying a workload placement algorithm that places workloads to achieve various goals, such as higher throughput, lower cost, reduced energy usage, or other factors. The scheduler 110 also considers unhealthy edge link information 115 provided by the link health monitor 112. The unhealthy edge link information 115 may identify any edge link in the network arrangement that has been predicted by the link health monitor 112 to be unhealthy. The scheduler 110 avoids placing workloads on any computing node that is connected over an unhealthy edge link to a switch.

The link health monitor 112 receives health metrics from computing nodes and switches. Based on analyzing the health metrics from the computing nodes and switches, the link health monitor 112 can determine the health of the edge links connecting the computing nodes to switches. Similarly, the fabric manager health monitor 108 receives health metrics from the switches. Based on analyzing the health metrics from the switches, the fabric manager health monitor 108 can predict the health of inter-switch links.

Although FIG. 1 shows an example with separate health monitors 108 and 112 in the fabric manager 102 and the health monitoring system 120, respectively, in other examples, just one health monitor can be provided. This health monitor can be part of the fabric manager 102 or the workload manager 104, or can be separate from the fabric manager 102 and the workload manager 104 such as in the health monitoring system 120.

A node health agent in a computing node collects edge link health metrics relating to communications over an edge link. Similarly, a switch health agent in a switch collects edge link health metrics relating to communications over edge links connecting the switch to computing nodes. Node health agents in respective computing nodes and switch health agents in respective switches send respective edge link health metrics to the fabric manager health monitor 108. Based on the edge link health metrics received from the node health agents and the switch health agents, the link health monitor 112 can identify any unhealthy edge links, which are edge links that are predicted to be unhealthy (e.g., the edge links are currently still operational but are degrading in health such that the edge links may fail in the future). In response to identifying an unhealthy edge link, the link health monitor 112 adds an entry to the unhealthy edge link information 115, with the entry containing an identifier of the unhealthy edge link. For example, the identifier of the unhealthy edge link can include a port number and a computing node identifier, where the computing node identifier identifies a computing node, and the port number identifies an edge port in the identified computing node to which the unhealthy edge link is connected.

The scheduler 110 in the workload manager 104 accesses the unhealthy edge link information 115 to determine which edge links are unhealthy. The scheduler 110 preemptively avoids placing new workloads on computing nodes connected to the unhealthy edge links.

The switch health agents in the switches also collect inter-switch link health metrics relating to communications over inter-switch links between switches. The switch health agents send the inter-switch link health metrics to the fabric manager health monitor 108, which analyzes the inter-switch link health metrics to identify unhealthy inter-switch links, which are inter-switch links that are predicted to be unhealthy (e.g., the inter-switch links are currently still operational but are degrading in health such that the inter-switch links may fail in the future). In response to identifying an unhealthy inter-switch link, the fabric manager health monitor 108 adds an entry to unhealthy inter-switch link information 116, with the entry containing an identifier of the unhealthy inter-switch link. For example, the identifier of the unhealthy inter-switch link can include a port number and a switch identifier, where the switch identifier identifies a switch, and the port number identifies a switch port in the identified switch to which the unhealthy inter-switch link is connected

The routing engine 106 accesses the unhealthy inter-switch link information 116 to determine which inter-switch links (local links or global links) are unhealthy. The routing engine 106 updates routing information in switches connected to the unhealthy inter-switch links so that the switches use the updated routing information to preemptively avoid forwarding data packets over the unhealthy inter-switch links.

By diverting traffic away from unhealthy network links before the network links actually fail or experience a fault that would cause packet drops, preemptive link fault mitigation systems and techniques according to some implementations of the present disclosure reduce the likelihood of traffic disruption due to network link failures or faults, and reduce the likelihood of workloads in computing nodes crashing or being delayed due to data communication errors.

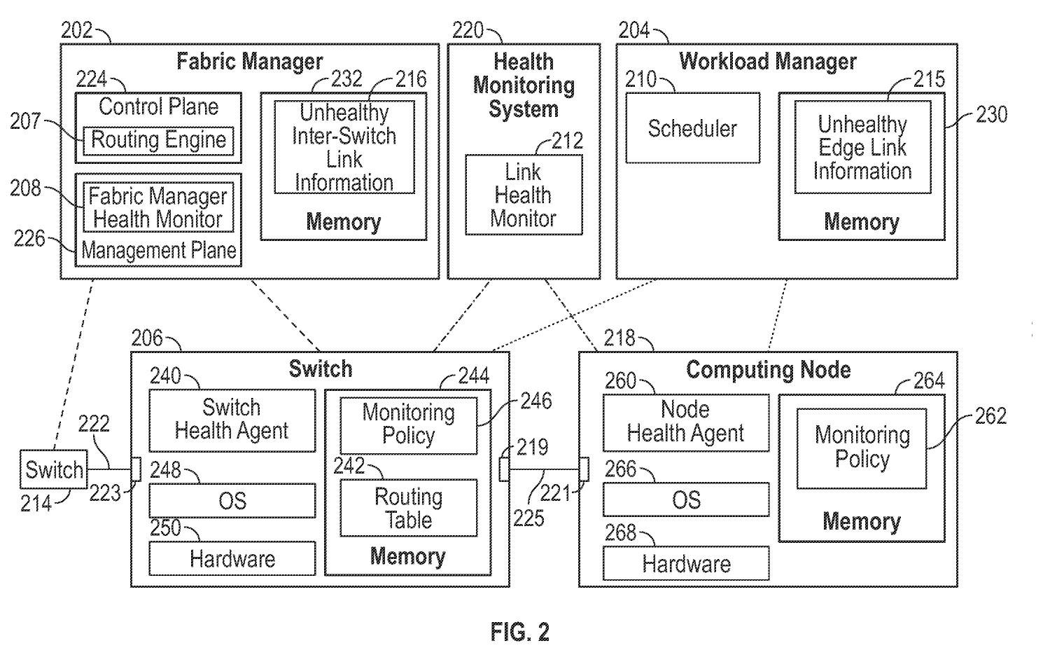

FIG. 2 is a block diagram an example arrangement that includes a fabric manager 202, a workload manager 204, a health monitoring system 220, switches 206 and 214, and a computing node 218. The switches 206 and 214 are examples of the switches of FIG. 1. The fabric manager 202 is an example of the fabric manager 102 of FIG. 1, and the workload manager 204 is an example of the workload manager 104 of FIG. 1. The computing node 218 is an example of any of the computing nodes of FIG. 1. The health monitoring system 220 including a link health monitor 212 is an example of the health monitoring system 120. In other examples, the separate health monitoring system 220 can be omitted, and the link health monitor 212 can be included in the workload manager 204. Also, although FIG. 2 shows a fabric manager health monitor 208 in the fabric manager 202, in further examples, the fabric manager health monitor 208 may be included in the health monitoring system 220 or another health monitoring system.

An edge link 225 connects an edge port 219 of the switch 206 to an edge port 221 of the computing node 218. An inter-switch link 222 connects a switch port 223 of the switch 206 to a switch port (not shown) of the switch 214.

The switch 206 includes a switch health agent 240 to collect health metrics relating to edge and inter-switch links. The computing node 218 includes a node health agent 260 to collect health metrics relating to edge links.

Examples of health metrics that can be collected by a health agent (the switch health agent 240 or the node health agent 260) can include any or some combination of the following: an error rate detected over a network link, a data transfer rate over a network link, or any other property indicative of a health of a network link. The health of a network link may be dependent upon several factors, including the condition of the physical medium of the network link, hardware circuitry (in the switch or computing node) connected to the network link, machine-readable instructions that perform communications of data over the network link, or other factors. A degradation in any of the foregoing factors may lead to an unhealthy network link.

A data error rate refers to a quantity of data errors observed per volume of data transferred or per unit time. For example, a data error can include data bit errors (errors in bits transferred over a network link), or data word errors (errors in words transferred over a network link, where a "word" can refer to a specified collection of bits of a predefined length). In some examples, a network link can be protected using forward error correction (FEC), in which a transmitter sends redundant data, and a receiver can detect and correct up to a specified quantity of data errors. For example, if the FEC uses Reed Solomon error correction, then up to 15 bits of error can be corrected. In further examples, error correction applied on data transferred over a network link can produce corrected code words. The number of errors in a corrected code word can be observed.

The fabric manager health monitor 208 is an example of the fabric manager health monitor 108 of FIG. 1, and the link health monitor 212 is an example of the link health monitor 112 of FIG. 1. A health monitor (208 or 212) can compare an observed error rate (as indicated in received health metrics) to an error rate threshold. If the observed error rate over a given network link exceeds the error rate threshold, then the health monitor can transition the given network link from a normal state to a watch state. The "normal state" of a network link refers to a state in which health metrics are collected at a first frequency ("normal state frequency"). The "watch state" of the network link refers to a state in which health metrics are collected at a higher second frequency ("watch state frequency").

In alternative examples, instead of the health monitor in the fabric manager 202 or the health monitoring system 220 comparing an observed error rate to the error rate threshold, a health agent (e.g., the health agent 240 in the switch 206 or the health agent 260 in the computing node 218) can compare the observed error rate to the error rate threshold. If the observed error rate exceeds the error rate threshold, the health agent transitions the given network link from the normal state to the watch state. The health agent also sends an alert to the health monitor that the given network link has been transitioned to the watch state. The alert can be in the form of a message, an information element, a signal, or any other indicator.

While the given network link is in the watch state, the health monitor can correlate observed error rates collected for the given network link with a target pattern to determine whether the observed error rates indicate that the given network link is trending towards degraded health. An example target pattern includes a trending pattern in which error rates are trending upwardly over time, which can indicate that something is wrong that may cause the given network link to fail in the future. If the pattern of the observed error rates match the target pattern to within a similarity threshold, then the observed error rates indicate that the given network link is unhealthy.

As a further example, the health monitor can determine a rate of change of the error rate. If the rate of change of the error rate increases above a change rate threshold, then the health monitor can make a determination that the given network link is unhealthy (the given network link is currently still operational but may go down in the future).

In further examples, the health monitor can additionally or alternatively monitor other health metrics, including the data transfer rate over a network link. For example, if the health monitor detects that the data transfer rate over the given network link has dropped below a transfer rate threshold, the health monitor can transition the given network link from the normal state to the watch state. While the given network link is in the watch state, the health monitor determines whether the given network link is unhealthy based on any or some combination of the following: (1) the observed data transfer rates are correlated with a target pattern (e.g., a trending pattern in which data transfer rates are trending downwardly over time), or (2) a rate of change of the observed data transfer rates.

Alternatively, instead of the health monitor in the fabric manager 202 or the health monitoring system 220 comparing an observed data transfer rate to the transfer rate threshold, a health agent (e.g., the health agent 240 in the switch 206 or the health agent 260 in the computing node 218) can compare the observed data transfer rate to the transfer rate threshold. If the observed data transfer rate drops below the transfer rate threshold, the health agent transitions the given network link from the normal state to the watch state. The health agent also sends an alert to the health monitor that the given network link has been transitioned to the watch state

More generally, a health monitor or a health agent determines whether a collection of health metrics for the given network link has satisfied a state transition criterion, and if so, the health monitor or the health agent transitions the network link from the normal state to the watch state. With the given network link in the watch state, the health monitor determines whether a collection of health metrics (collected at the higher watch state frequency) satisfies an unhealthy link criterion (e.g., based on correlating the collection of health metrics to a target pattern or detecting a rate of change of the collection of health metrics). If the collection of health metrics satisfies the unhealthy link criterion, the health monitor makes a determination that the given network link is unhealthy. An "unhealthy link criterion" is a criterion specifying one or more conditions that if satisfied by health metrics indicates that a network link is unhealthy. An "unhealthy" network link is a network link whose condition has degraded so that the network link may exhibit a failure or fault.

In other examples, the concept of a watch state for a network link can be omitted, so that transitions of network links between different states associated with different collection frequencies are omitted. In such examples, health metrics are collected at a particular frequency (or in response to any other event), and the health monitor determines whether the collected health metrics for network links satisfy the unhealthy link criterion.

If the health monitor determines that the given network link is unhealthy, the health monitor can perform any of various actions. For example, the health monitor can update unhealthy link information. The fabric manager health monitor 208 can add an entry to unhealthy inter-switch link information 216 that is stored in a memory 232 of the fabric manager 202, where the added entry can identify an unhealthy inter-switch link. The link health monitor 212 can add an entry to unhealthy edge link information 215 that is stored in a memory 230 of the workload manager 204, where the added entry can identify an unhealthy edge link. In addition, the health monitor can issue an alert in response to detecting an unhealthy network link.

In an example, the fabric manager health monitor 208 can send an alert to a routing engine 207 of the fabric manager 202, or to another entity (whether inside or outside the fabric manager 202). The routing engine 207 is an example of the routing engine 106 of FIG. 1. The routing engine 207 can take action in response to the alert for addressing an unhealthy inter-switch link. The action can include updating routing tables in switches to divert traffic away from the unhealthy inter-switch link to avoid data packet loss. As an example, the switch 206 includes a routing table 242 stored in a memory 244 of the switch 206. Once routing tables have been updated to divert traffic away from the unhealthy inter-switch link, the unhealthy inter-switch link can be taken down for repair, such as to replace any defective hardware or to update faulty machine-readable instructions.

The link health monitor 212 can send an alert to a scheduler 210 of the workload manager 204, or to another entity (whether inside or outside the workload manager 204). The scheduler 210 can take action in response to the alert for addressing an unhealthy edge link. The action can include placing a computing node, such as the computing node 218, into a maintenance mode. In the maintenance mode, any existing workload on the computing node is allowed to complete. However, the scheduler 110 does not schedule any new workloads on the computing node that is in the maintenance mode. Not scheduling new workloads on the computing node in the maintenance mode ensures that traffic of such new workloads would not be propagated over the unhealthy edge link to avoid data packet loss.

The routing engine 207 is part of a control plane 224 of the fabric manager 202, and the fabric manager health monitor 208 is part of a management plane 226 of the fabric manager 202. Generally, the control plane 224 of the fabric manager 202 controls how switches of a network arrangement are to route data packets. The management plane 226 performs management tasks with respect to the switches, including health monitoring, updating programs in the switches, performing maintenance in the switches, or other management tasks.

The switch 206 further stores a monitoring policy 246 in the memory 244 of the switch 206. The switch health agent 240 monitors health metrics related to network links to which the switch 206 is connected according to the monitoring policy 246. The monitoring policy 246 can specify which metrics are to be collected by the switch health agent 240 and sent to a health monitor (e.g., 208 or 212). The monitoring policy 246 can also specify frequencies at which health metrics are to be collected. The frequencies can include a normal state frequency at which health metrics are collected for a network link in the normal state. The frequencies can also include a watch state frequency (higher than the normal state frequency) at which health metrics are collected for a network link in the watch state.

When a health monitor (208 or 212) transitions a given network link connected to the switch 206 from the normal state to the watch state, the health monitor sends a notification of the watch state transition to the switch health agent 240. The notification can be in the form of a message, an information element, a signal, or any other indicator. In response to the notification, the switch health agent 240 collects health metrics at the higher watch state frequency.

The switch 206 also includes an operating system (OS) 248 and a hardware layer 250. The hardware layer 250 can include one or more hardware components, including a hardware routing component to perform routing of data packets. For example, the hardware routing component can include a programmable logic device, such as an application-specific integrated circuit (ASIC) device, a programmable gate array (FPGA), or any other type of programmable logic device. Alternatively, the hardware routing component can include a central processing unit (CPU) or another type of hardware processor. Further, the hardware layer 250 may include a management processor that performs management tasks in cooperation with the management plane 226 of the fabric manager 202. Additionally, the hardware layer 250 can include ports of the switch 206.

Although specific layers of the switch 206 are shown in FIG. 2, in other examples, there may be additional layers of the switch 206 that perform other services.

The computing node 218 stores a monitoring policy 262 in a memory 264 of the computing node 218. The node health agent 260 monitors health metrics related to an edge link to which the node health agent 260 is connected according to the monitoring policy 262. The monitoring policy 262 can specify which metrics are to be collected by the node health agent 260 and sent to the link health monitor 212. The monitoring policy 262 can also specify frequencies at which health metrics are to be collected. The frequencies can include a normal state frequency at which health metrics are collected for an edge link in the normal state. The frequencies can also include a watch state frequency (higher than the normal state frequency) at which health metrics are collected for the edge link in the watch state.

When the link health monitor 212 transitions the edge link connected to the computing node 218 from the normal state to the watch state, the link health monitor 212 sends a notification of the watch state transition to the node health agent 260. In response to the notification, the node health agent 260 collects health metrics at the higher watch state frequency.

The computing node 218 also includes an OS 266 and a hardware layer 268. The hardware layer 268 can include a CPU (or multiple CPUs), a network interface controller (NIC) to communicate with a switch, and other hardware components. The scheduler 210 in the workload manager 204 can place one or more workloads to execute on the CPU(s) of the computing node 218.

Although specific layers of the computing node 218 are shown in FIG. 2, in other examples, there may be additional layers of the computing node 218 that perform other services.

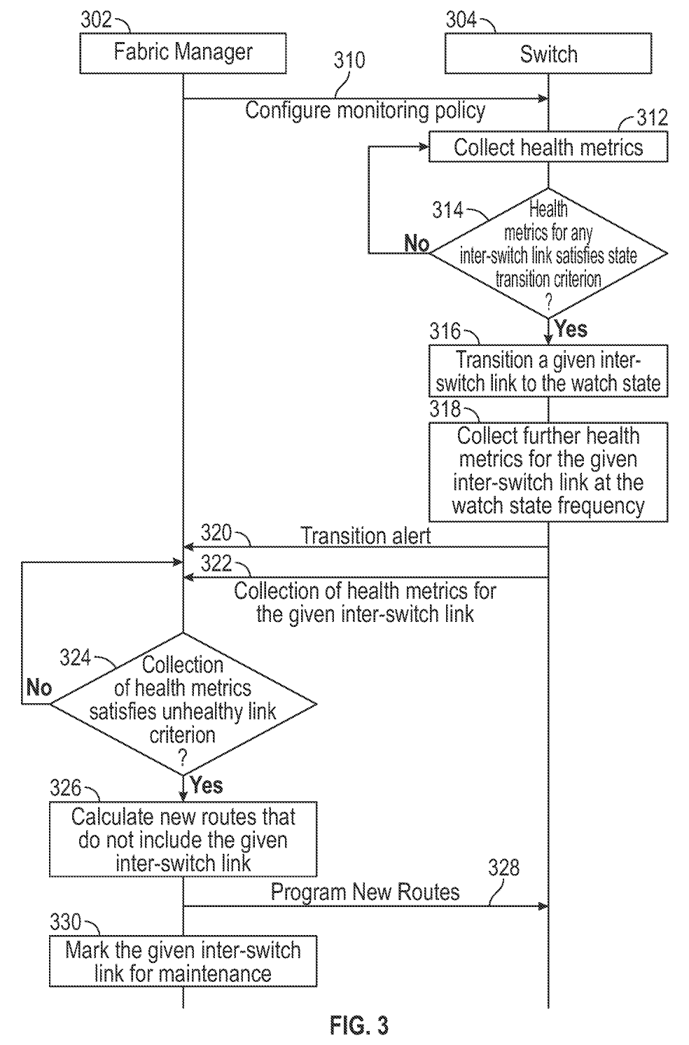

FIG. 3 is a flow diagram of a process of detecting and addressing unhealthy inter-switch links, in accordance with some examples of the present disclosure. Although FIG. 3 shows a specific order of tasks, in other examples, the tasks may be performed in a different order, some of the tasks may be omitted, and other tasks may be added.

A fabric manager health monitor (e.g., 108 in FIG. 1 or 208 in FIG. 2) in a fabric manager 302 (which is similar to the fabric manager 102 of FIG. 1 or 202 of FIG. 2) configures(at 310) switches, including a switch 304, with a monitoring policy (e.g., 246 in FIG. 2) for inter-switch links. This configuration can be accomplished by the fabric manager health monitor sending the monitoring policy to the switches, which store the monitoring policy in the memories of the switches.

A switch health agent (e.g., 240 in FIG. 2) in the switch 304 collects (at 312) health metrics according to the monitoring policy. Initially, the health metrics are collected at the normal state frequency. The collected metrics are for inter-switch links (local links and any global links) connected to switch ports of the switch 304. In some examples, the switch health agent determines (at 314) whether the collected health metrics for any inter-switch link satisfies the state transition criterion (e.g., an observed data error rate exceeds the error rate threshold, or an observed data transfer rate drops below the transfer rate threshold). A "state transition criterion" is a criterion specifying one or more conditions that if satisfied by health metrics would trigger a transition of a network link between different states, where the different states may be associated with different frequencies at which health metrics are collected. If none of the collected health metrics for the inter-switch links satisfy the state transition criterion, the switch health agent continues to collect health metrics at the normal state frequency.

If the switch health agent determines (at 314) that the collected health metrics for a given inter-switch link satisfies the state transition criterion, the switch health agent transitions (at 316) the given inter-switch link from the normal state to the watch state, and the switch health agent collects (at 318) further health metrics for the given inter-switch link at the higher watch state frequency. Note that health metrics for inter-switch links that remain at the normal state are still collected at the normal state frequency.

The switch health agent also sends (at 320) an alert to the fabric manager health monitor that the given inter-switch link has been transitioned to the watch state.

In alternative examples, instead of the switch health agent making the determination of whether the collection of health metrics for any inter-switch link has satisfied the state transition criterion, the fabric manager health monitor in the fabric manager 302 can make this determination. The fabric manager health monitor can transition an inter-switch link to the watch state, and the fabric manager health monitor can issue an alert of the transition to the switch health agent to trigger the switch health agent to collect health metrics for the inter-switch link at the watch state frequency.

The collection of health metrics collected at the higher watch state frequency for the given inter-switch link is sent (at 322) by the switch health agent to the fabric manager health monitor. The fabric manager health monitor determines (at 324) whether the collection of health metrics for the given inter-switch link satisfies the unhealthy link criterion (e.g., based on correlating the collection of health metrics to a target pattern or detecting a rate of change of the collection of health metrics). If not, the fabric manager health monitor continues to receive a further collection of health metrics for the given inter-switch link and re-iterates task 322.

If the collection of health metrics for the given inter-switch link satisfies the unhealthy link criterion, the fabric manager health monitor notifies a routing engine (e.g., 108 in FIG. 1 or 206 in FIG. 2) in the fabric manager 302, and the routing engine calculates (at 326) new routes for data packets that do not include the given inter-switch link. The routing engine programs (at 328) the new routes into routing tables of switches, including the switch 304, to divert data packets away from the given inter-switch link.

The fabric manager health monitor also marks (at 330) the given inter-switch link for maintenance. This marking can include sending a notification to a target entity (e.g., a network administrator, a program, or a machine) that the given inter-switch link is down for maintenance so a repair action for the given inter-switch link can be initiated.

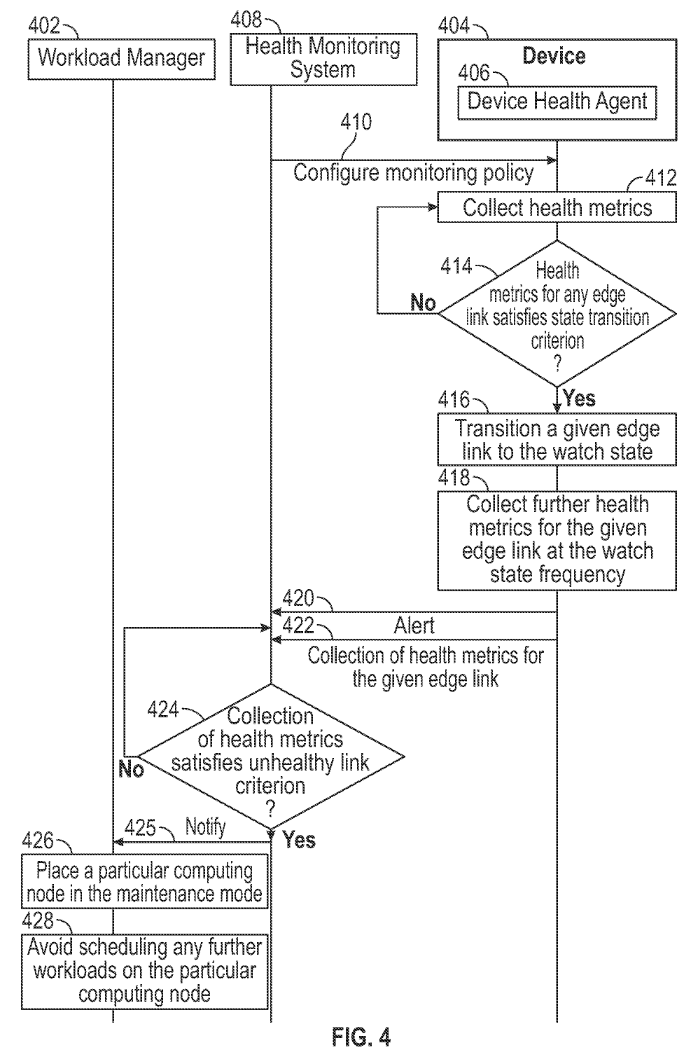

FIG. 4 is a flow diagram of a process of detecting and addressing unhealthy edge links, in accordance with some examples of the present disclosure. Although FIG. 4 shows a specific order of tasks, in other examples, the tasks may be performed in a different order, some of the tasks may be omitted, and other tasks may be added.

A link health monitor of a health monitoring system 408 (e.g., 120 in FIG. 1 or 220 in FIG. 2) configures(at 410) devices, including a device 404, with a monitoring policy (e.g., 246 or 262 in FIG. 2). This configuration can be accomplished by the health monitoring system 408 sending the monitoring policy to the devices, which store the monitoring policy in memories of the devices. The devices can include switches and computing nodes. The device 404 is a switch or a computing node. Other devices can perform tasks similar to the tasks shown in FIG. 4 for the device 404. In other examples, the separate health monitoring system 408 is omitted; in such examples, a link health monitor is included in a workload manager 402.

A device health agent 406 (e.g., the switch health agent 240 or the node health agent 260 in FIG. 2) in the device 404 collects (at 412) health metrics according to the monitoring policy. Initially, the health metrics are collected at the normal state frequency. The collected metrics are for edge links connecting computing nodes to node ports of switches. In some examples, the device health agent 406 determines (at 414) whether the collected health metrics for any edge link satisfies the state transition criterion (e.g., an observed data error rate exceeds the error rate threshold, or an observed data transfer rate drops below the transfer rate threshold). If none of the collected health metrics for the edge links satisfy the state transition criterion, the device health agent 406 continues to collect health metrics at the normal state frequency.

If the device health agent 406 determines (at 414) that the collected health metrics for a given edge link satisfies the state transition criterion, the device health agent 406 transitions (at 416) the given edge link from the normal state to the watch state, and the device health agent 406 collects (at 418) further health metrics for the given edge link at the higher watch state frequency. Note that health metrics for edge links that remain at the normal state are still collected at the normal state frequency.

The device health agent 406 also sends (at 420) an alert to the health monitoring system 408 that the given edge link has been transitioned to the watch state.

In alternative examples, instead of the device health agent 406 making the determination of whether the collection of health metrics for any edge link has satisfied the state transition criterion, the link health monitor in the health monitoring system 408 can make this determination. The link health monitor can transition an edge link to the watch state, and the link health monitor can issue an alert of the transition to the device health agent 406 to trigger the device health agent 406 to collect health metrics for the edge link at the watch state frequency.

The collection of health metrics collected at the higher watch state frequency for the given edge link is sent (at 422) by the device health agent 406 to the health monitoring system 408. The link health monitor in the health monitoring system 408 determines (at 424) whether the collection of health metrics for the given edge link satisfies the unhealthy link criterion (e.g., based on correlating the collection of health metrics to a target pattern or detecting a rate of change of the collection of health metrics). If not, the link health monitor continues to receive a further collection of health metrics for the given edge link and re-iterates task 422.

If the collection of health metrics for the given edge link satisfies the unhealthy link criterion, the link health monitor notifies (at 425) a scheduler (e.g., 110 in FIG. 1 or 210 in FIG. 2) in the workload manager 402 of the unhealthy given edge link. In response, the scheduler places (at 426) a particular computing node connected to the given edge link in the maintenance mode. While the particular computing node is in the maintenance mode, the scheduler avoids (at 428) scheduling any further workloads on the particular computing node. However, any existing workloads on the particular computing node is allowed to continue to completion. Not scheduling any further workloads on the particular computing node effectively diverts data packets of such further workloads away from the given edge link.

The placement of the particular computing node in the maintenance mode also triggers the sending of a notification to a target entity (e.g., a network administrator, a program, or a machine) that the particular computing node is to be repaired.

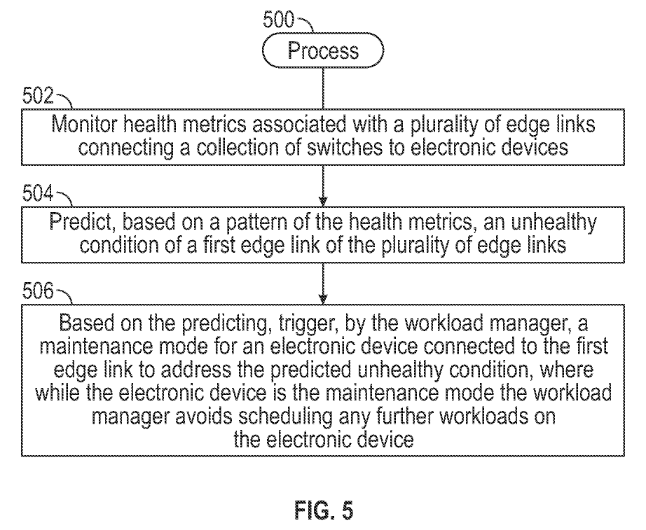

FIG. 5 is a flow diagram of a process 500 according to some examples of the present disclosure. The process 500 can be performed by a system, which can include the workload manager 104, 204, or 402, and the health monitoring system 120, 220, or 408 depicted in FIG. 1, 2, or 4, respectively. In other examples, the process 500 can be performed without the use of the separate health monitoring system 120, 220, or 408.

The process 500 includes monitoring (at 502) health metrics associated with a plurality of edge links connecting a collection of switches to electronic devices. Examples of electronic devices include computing nodes as shown in FIG. 1 or 2. Electronic devices can include any or some combination of the following: a desktop computer, a notebook computer, a tablet computer, a communication node, a storage system, or any other type of electronic device. "Monitoring" health metrics can refer to receiving the health metrics and applying computations on the health metrics.

The process 500 includes predicting (at 504), based on a pattern of the health metrics, an unhealthy condition of a first edge link of the plurality of edge links. An "unhealthy condition" of an edge link refers to a condition in which the edge link has degraded so that the edge link may exhibit a failure or fault. "Predicting" the unhealth condition of a network link (such as the first edge link) includes assessing the health metrics collected for the network link to make a determination that the network link is likely to fail or experience a fault.

Based on the predicting, the process 500 includes triggering (at 506), by the workload manager, a maintenance mode for an electronic device connected to the first edge link to address the predicted unhealthy condition, where while the electronic device is in the maintenance mode the workload manager avoids scheduling any further workloads on the electronic device. "Triggering" the maintenance mode can include marking the electronic device as ineligible or undesirable for placement of any further workload so that a maintenance action can be taken with respect to the electronic device or a switch or an edge link.

In some examples, data of an existing workload running on the electronic device can be communicated over the first edge link while the electronic device is in the maintenance mode. Such communication is to allow the existing workload to run to completion before the electronic device is taken down for the maintenance action to resolve the unhealthy condition of the first edge link.

In some examples, the system monitors further health metrics associated with a plurality of inter-switch links (e.g., local links and global links) connecting switches of the collection of switches. The system predicts, based on a pattern of the further health metrics, an unhealthy condition of a first inter-switch link of the plurality of inter-switch links. Based on predicting the unhealthy condition of the first inter-switch link, a fabric manager in the system triggers an update of forwarding information in at least one switch connected to the first inter-switch link, the updated forwarding information diverting subsequently transmitted data away from the first inter-switch link. An example of forwarding information includes routing information such as a routing table, which is used to route data packets based on IP addresses in the data packets. Alternatively, forwarding information can include a MAC table that forwards data packets based on MAC addresses in the data packets.

In some examples, the collection of switches includes a first group of switches, where each switch of the first group of switches is connected by local links to each other switch of the first group of switches, and where the further health metrics include health metrics associated with the local links. The first group of switches can include any of the switch groups in FIG. 1.

In some examples, the collection of switches includes a second group of switches, the second group of switches connected over a global link to the first group of switches, where the further health metrics include health metrics associated with the global link.

In some examples, the predicting of the unhealthy condition of the first edge link based on the pattern of the health metrics includes detecting that the health metrics are negatively trending over time. For example, data error rates negatively trend over time if the data error rates are trending upwardly over time. As another example, data transfer rates negatively trend over time if the data transfer rates are trending downwardly over time.

In some examples, the predicting the unhealthy condition of the first edge link based on the pattern of the health metrics including detecting that a rate of change of the health metrics exceeds a rate change threshold.

In some examples, the health metrics associated with the plurality of edge links are monitored in periodic intervals according to a first frequency (e.g., the normal state frequency).

In some examples, the system detects that a collection of health metrics for the first edge link satisfies a transition criterion. Based on detecting that the collection of health metrics satisfies the transition criterion, the system increases a frequency at which health metrics for the first edge link are monitored (e.g., to the watch state frequency).

In some examples, the system determines whether a further collection of health metrics for the first edge link collected at the increased frequency satisfies an unhealthy link criterion. The predicting of the unhealthy condition of the first edge link is based on the further collection of health metrics satisfying the unhealthy link criterion.

In some examples, the collection of health metrics includes a data error rate for the first edge link, and the transition criterion includes the data error rate exceeding an error rate threshold.

In some examples, the collection of health metrics includes a data transfer rate over the first edge link, and the transition criterion includes the data transfer rate dropping below a transfer rate threshold.

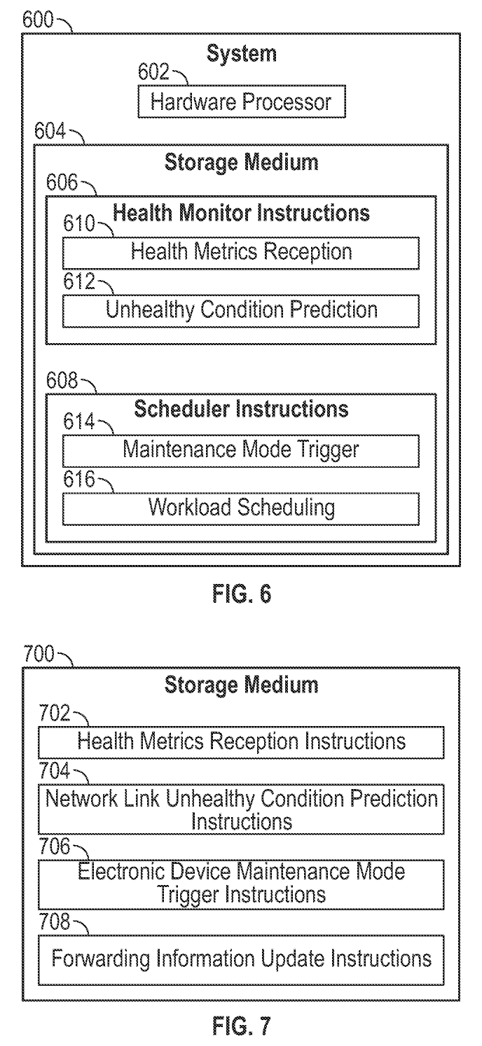

FIG. 6 is a block diagram of a system 600 according to some examples of the present disclosure. In an example, the system 600 can include a combination of a health monitoring system (e.g., 120, 220, or 408 in FIG. 1, 2, or 4, respectively) and a workload manager (e.g., 104, 204, or 402 of FIG. 1, 2, or 4, respectively. In another example, the system 600 includes the workload manager 104, 204, or 402 of FIG. 1, 2, or 4, respectively (e.g., a separate health monitoring system is not used).

The system 600 includes a hardware processor 602 (or multiple hardware processors). A hardware processor can include a microprocessor, a core of a multi-core microprocessor, a microcontroller, a programmable integrated circuit, a programmable gate array, or another hardware processing circuit.

The system 600 includes a storage medium 604 storing health monitor instructions 606 and scheduler instructions 608. The health monitor instructions 606 are executable on the hardware processor 602 to perform various tasks. Machine-readable instructions executable on a hardware processor can refer to the instructions executable on a single hardware processor or the instructions executable on multiple hardware processors.

The health monitor instructions 606 may be part of the link health monitor 112 or 212 of FIG. 1 or 2, respectively, and the scheduler instructions 608 may be part of the scheduler 110 or 210 of FIG. 1 or 2, respectively.

The health monitor instructions 606 are executable to receive health metrics (610) associated with a plurality of edge links connecting a collection of switches to electronic devices. The health monitor instructions 606 are executable to predict, based on a pattern of the health metrics, an unhealthy condition (612) of a first edge link of the plurality of edge links.

The scheduler instructions 608 are executable to, based on the predicting, trigger a maintenance mode (614) for an electronic device connected to the first edge link to address the predicted unhealthy condition, and while the electronic device is in the maintenance mode, schedule further workloads away from the electronic device (616).

FIG. 7 is a block diagram of a non-transitory machine-readable or computer-readable storage medium 700 storing machine-readable instructions that upon execution cause a system to perform various tasks. For example, the machine-readable instructions may be executable in any combination of the fabric manager 102, 202, or 302 of FIG. 1, 2, or 3, respectively, the workload manager 104, 204, or 402, of FIG. 1, 2, or 4, respectively, and the health monitoring system 120, 220, or 408 of FIG. 1, 2, or 4, respectively.

The machine-readable instructions include health metrics reception instructions 702 to receive health metrics associated with network links, the network links interconnecting switches and electronic devices. The network links include inter-switch links connecting the switches to one another, and edge links connecting the electronic devices to the switches.

The machine-readable instructions include network link unhealthy condition prediction instructions 704 to predict, based on a pattern of the health metrics, an unhealthy condition of a first edge link of the edge links, and an unhealthy condition of a first inter-switch link of the inter-switch links. As examples, the pattern can include a trending pattern, or health metrics violating a change rate threshold.

The machine-readable instructions include electronic device maintenance mode trigger instructions 706 and forwarding information update instructions 708 that are performed based on the predicting. The electronic device maintenance mode trigger instructions 706 can trigger a maintenance mode for an electronic device connected to the first edge link to address the predicted unhealthy condition of the first edge link, where while the electronic device is in the maintenance mode, a workload manager schedules further workloads away from the electronic device. The forwarding information update instructions 708 can update forwarding information in a subset of the switches to divert traffic away from the first inter-switch link.

As used here, a "computing node" can refer to a computer or multiple computers. A "memory" can be implemented using one or more memory devices, such as dynamic random access memory (DRAM) devices, static random access memory (SRAM) devices, erasable and programmable read-only memory (EPROM) devices, electrically erasable and programmable read-only memory (EEPROM) devices, or flash memory devices.

A "CPU" includes one or more hardware processors.

An "engine" can refer to one or more hardware processing circuits, which can include any or some combination of a microprocessor, a core of a multi-core microprocessor, a microcontroller, a programmable integrated circuit, a programmable gate array, or another hardware processing circuit. Alternatively, an "engine" can refer to a combination of one or more hardware processing circuits and machine-readable instructions (software and/or firmware) executable on the one or more hardware processing circuits.

A storage medium (e.g., 604 in FIG. 6 or 700 in FIG. 7) can include any or some combination of the following: a semiconductor memory device such as a DRAM or SRAM, an EPROM, an EEPROM, or a flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term "a," "an," or "the" is intended to include the plural forms as well, unless the context clearly indicates otherwise. Also, the term "includes," "including," "comprises," "comprising," "have," or "having" when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A method comprising:
monitoring, by a system comprising a hardware processor, health metrics associated with a plurality of edge links connecting a collection of switches to electronic devices
predicting, by the system based on a pattern of the health metrics, an unhealthy condition of a first edge link of the plurality of edge links; and
based on the predicting, triggering, by a workload manager in the system, a maintenance mode for an electronic device connected to the first edge link to address the predicted unhealthy condition, wherein while the electronic device is in the maintenance mode the workload manager avoids scheduling any further workloads on the electronic device.

2. The method of claim 1, comprising:
communicating data of an existing workload running on the electronic device over the first edge link while the electronic device is in the maintenance mode.

3. The method of claim 2, comprising:
after completing a communication of data for the existing workload over the first edge link, performing maintenance on the first edge link to resolve the unhealthy condition of the first edge link.

4. The method of claim 1, comprising:
monitoring, by the system, further health metrics associated with a plurality of inter-switch links connecting switches of the collection of switches;
predicting, by the system based on a pattern of the further health metrics, an unhealthy condition of a first inter-switch link of the plurality of inter-switch links; and
based on predicting the unhealthy condition of the first inter-switch link, triggering, by a fabric manager in the system, an update of forwarding information in at least one switch connected to the first inter-switch link, the updated forwarding information diverting subsequently transmitted data away from the first inter-switch link.

5. The method of claim 4, wherein the collection of switches comprises a first group of switches, wherein each switch of the first group of switches is connected by local links to each other switch of the first group of switches, and wherein the further health metrics comprise health metrics associated with the local links.

6. The method of claim 5, wherein the collection of switches comprises a second group of switches, the second group of switches connected over a global link to the first group of switches, and wherein the further health metrics comprise health metrics associated with the global link.

7. The method of claim 1, wherein the predicting of the unhealthy condition of the first edge link based on the pattern of the health metrics comprises detecting that the health metrics are negatively trending over time.

8. The method of claim 1, wherein the predicting the unhealthy condition of the first edge link based on the pattern of the health metrics comprises detecting that a rate of change of the health metrics exceeds a rate change threshold.

9. The method of claim 1, wherein the health metrics associated with the plurality of edge links are monitored in periodic intervals according to a first frequency.

10. The method of claim 9, comprising:
detecting that a collection of health metrics for the first edge link satisfies a transition criterion; and
based on detecting that the collection of health metrics satisfies the transition criterion, increasing a frequency at which health metrics for the first edge link are monitored.

11. The method of claim 10, comprising:
determining, by the system, whether a further collection of health metrics for the first edge link collected at the increased frequency satisfies an unhealthy link criterion,
wherein the predicting of the unhealthy condition of the first edge link is based on the further collection of health metrics satisfying the unhealthy link criterion.

12. The method of claim 10, wherein the collection of health metrics comprises a data error rate for the first edge link, and the transition criterion comprises the data error rate exceeding an error rate threshold.

13. The method of claim 10, wherein the collection of health metrics comprises a data transfer rate over the first edge link, and the transition criterion comprises the data transfer rate dropping below a transfer rate threshold.

14. The method of claim 1, wherein the health metrics are collected by device health agents in the electronic devices and switch health agents in the collection of switches.

15. The method of claim 14, wherein the predicting of the unhealthy condition of the first edge link is performed by the workload manager.

16. A system comprising:
a hardware processor; and
a non-transitory storage medium storing health monitor instructions and scheduler instructions, the health monitor instructions executable on the hardware processor to:
receive health metrics associated with a plurality of edge links connecting a collection of switches to electronic devices, and
predict, based on a pattern of the health metrics, an unhealthy condition of a first edge link of the plurality of edge links, and
the scheduler instructions executable on the hardware processor to:
based on the predicting, trigger a maintenance mode for an electronic device connected to the first edge link to address the predicted unhealthy condition, and
while the electronic device is in the maintenance mode, schedule further workloads away from the electronic device.

17. The system of claim 16, wherein the predicting of the unhealthy condition of the first edge link based on the pattern of the health metrics comprises detecting that the health metrics are negatively trending over time.

18. The system of claim 16, wherein the predicting the unhealthy condition of the first edge link based on the pattern of the health metrics comprises detecting that a rate of change of the health metrics exceeds a rate change threshold.

19. A non-transitory machine-readable storage medium comprising instructions that upon execution cause a system to:
receive health metrics associated with network links, the network links interconnecting switches and electronic devices, and the network links comprising inter-switch links connecting the switches to one another, and edge links connecting the electronic devices to the switches;
predict, based on a pattern of the health metrics, an unhealthy condition of a first edge link of the edge links, and an unhealthy condition of a first inter-switch link of the inter-switch links; and
based on the predicting:
trigger a maintenance mode for an electronic device connected to the first edge link to address the predicted unhealthy condition of the first edge link, wherein while the electronic device is in the maintenance mode, a workload manager schedules further workloads away from the electronic device, and
update forwarding information in a subset of the switches to divert traffic away from the first inter-switch link.

20. The non-transitory machine-readable storage medium of claim 19, wherein the triggering of the maintenance mode is performed by the workload manager, and the updating of the forwarding information is performed by a fabric manager.
